(19) United States
(12) Patent Application Publication
(10) Pub. No.: US 2009/0031061 A1
(43) Pub. Date: Jan. 29, 2009

(54) HOST APPARATUS CAPABLE OF CONNECTING WITH AT LEAST ONE DEVICE USING WUSB AND METHOD OF CONNECTING HOST APPARATUS TO DEVICE

(75) Inventor: Jun-seung Lee, Seongnam-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/061,054

(22) Filed: Apr. 2, 2008

(30) Foreign Application Priority Data
Jul. 23, 2007 (KR) 10-2007-0073505

(51) Int. Cl. G06F 13/12

(52) U.S. Cl. 710/63

(57) ABSTRACT

A host apparatus capable of connecting with one or more devices using a wireless universal serial bus (WUSB) and a method of connecting the host apparatus to one or more devices. The method includes receiving a connection request signal for connecting to the host apparatus from one of the devices; and selectively responding to the connection request signal of the device according to preset device information. Accordingly, the host can be selectively connected with the device according to the preset connection option of the device. Hence the device can be connected with the host apparatus only when a user wants, and thus user convenience increases in using and managing the device through the host apparatus in the USB environment.

### CROSS-REFERENCE TO RELATED APPLICATIONS

This application claims the priority of Korean Patent Application No. 10-2007-0073505, filed on Jul. 23, 2007, in the Korean Intellectual Property Office, the disclosure of which is incorporated herein by reference, in its entirety.

### BACKGROUND OF THE INVENTION

1. Field of the Invention

The present general inventive concept relates to a host apparatus capable of connecting with one or more devices using a wireless universal serial bus (WUSB) and a method of connecting the host apparatus to the devices.

2. Description of the Related Art

Conventionally, in a universal serial bus (USB) communication, a user physically connects or disconnects a host apparatus with a device by plugging in or out a USB cable therebetween. However, in a wireless USB communication, since there is no actual cable to connect between the host apparatus and the device, the host device does not have to control the connection and disconnection with the device.

In the course of connecting between the host apparatus and the device using a wireless USB, generally, the device issues a connection request signal to the host apparatus, and the host apparatus receives the connection request signal and sends a response signal to the device, thus establishing a connection between the host apparatus and the device. Generally, since the device issues the connection request signal upon powering up, the connection between the host apparatus and the device is automatically initiated regardless of the user's intention when the device is powered up. That is, the connection status in the wireless USB communication becomes the same as that in a wired USB connection when the cable is connected between the device and the host apparatus upon powering up the device.

Such a conventional method of wireless USB communication may be convenient if a device such as a mouse or keyboard is always connected with a host apparatus, but when a device such as a printer is not always necessarily connected with the host apparatus, it may be more convenient for a user to establish a connection between the device and the host apparatus only when the user wants to use the device.

For example, a personal computer (PC) and a laptop can function as host apparatuses, a printer acts as a shared device of the host apparatuses on a wireless USB network and the PC uses the printer frequently while the laptop seldom uses the printer. In this case, whichever of the PC or the laptop is powered on first will be connected with the printer in response to a connection request signal of the printer. Thus, if the laptop is powered on before the PC and connected with the printer, it causes the user inconvenience that he/she needs to terminate the connection between the laptop and the printer using a system management of the printer when he/she wants to use the PC for printing.

### SUMMARY OF THE INVENTION

The present general inventive concept provides a host apparatus which can connect to one or more devices according to connection options preset in the devices using a wireless universal serial bus (USB), and a method of connecting the host apparatus to the devices.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept, can be achieved by providing a method of connecting a host apparatus with one or more devices by using a wireless universal serial bus (USB), the method including: receiving a connection request signal to connect to the host apparatus from one of a plurality of devices; and selectively responding to the connection request signal of the device according to preset device information.

The foregoing and/or other aspects and utilities of the present general inventive concept, can be achieved by providing a computer readable medium having computer readable code to implement a method of connecting a host apparatus with one or more devices using a wireless USB, the method including receiving a connection request signal to connect to the host apparatus from one of a plurality of devices and selectively responding to the connection request signal of the device according to preset device information.

The foregoing and/or other aspects and utilities of the present general inventive concept can also be achieved by providing a host apparatus which can connect to one or more devices using a wireless USB, the host apparatus including: a communication unit which receives connection request signals from the devices; a storage unit which stores device information of each of the devices; and a connection management unit which selectively responds to the received connection request signal of each device according to the device information, such that when the storage unit delivers the associated device information to the connection management unit, the connection management unit decides whether to establish a connection between the host and the device.

The foregoing and/or other aspects and utilities of the present general inventive concept can also be achieved by providing a computer readable recording medium having embodied thereon a computer program for executing a method of connecting a host apparatus with one or more devices using a wireless USB.

The foregoing and/or other aspects and utilities of the present general inventive concept can also be achieved by providing a device which can be connected with the host apparatus only when a user wants, and thus user convenience increases in using and managing the device through the host apparatus in the USB environment.

The foregoing and/or other aspects and utilities of the present general inventive concept, can also be achieved by providing a communication system, the system including: a host apparatus; at least one device operatively associated with the host for wireless communication, the device including a storage unit to store a set of device information data, the device information data including a connection option wherein the device waits until receiving a connection command from the host apparatus to enable a connection between the host apparatus and the device; and a wireless universal serial bus operatively associated with the host apparatus and each device for wireless communication.

The foregoing and/or other aspects and utilities of the present general inventive concept, can also be achieved by providing a method of controlling a communications system having a host apparatus, a wireless universal serial bus and at least one device, the method including: receiving a connection request signal to connect the host apparatus to at least one of the devices, and at least one of the devices including structure to store a set of device information, the device information including a connection option wherein the device waits until receiving a connection command from the host apparatus to enable a connection between the host apparatus and the device; and electronically determining whether the one device includes the connection option.

The foregoing and/or other aspects and utilities of the present general inventive concept, can also be achieved by providing a method of controlling a communications system having a host apparatus, a wireless universal serial bus and at least one electronic device, the method including receiving a connection request signal to connect the host apparatus to at least one of the devices, and at least one of the devices including structure to store a set of device information, the device information including a connection option wherein the device waits until receiving a connection command from the host apparatus to enable a connection between the host apparatus and the device and selectively responding to the connection request signal of the device according to preset device information.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a structural block diagram of a wireless connection system including a host apparatus and a plurality of devices, according to an embodiment of the present general inventive concept;

FIG. 2 is a detailed structural block diagram of a host apparatus of the wireless connection system of FIG. 1, according to an embodiment of the present general inventive concept;

FIG. 3 is a block diagram illustrating a data structure of device information according to an embodiment of the present general inventive concept;

FIG. 4 illustrates an example of displaying devices through a user interface of the host apparatus of FIG. 2, according to an embodiment of the present general inventive concept;

FIG. 5 is a flowchart illustrating a method of connecting a host apparatus with a device, according to an embodiment of the present general inventive concept;

FIG. 6 is a flowchart illustrating a method of terminating a connection between a host apparatus and a device, according to an embodiment of the present general inventive concept; and

FIG. 7 is a flowchart illustrating a method of setting property values of device information, according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

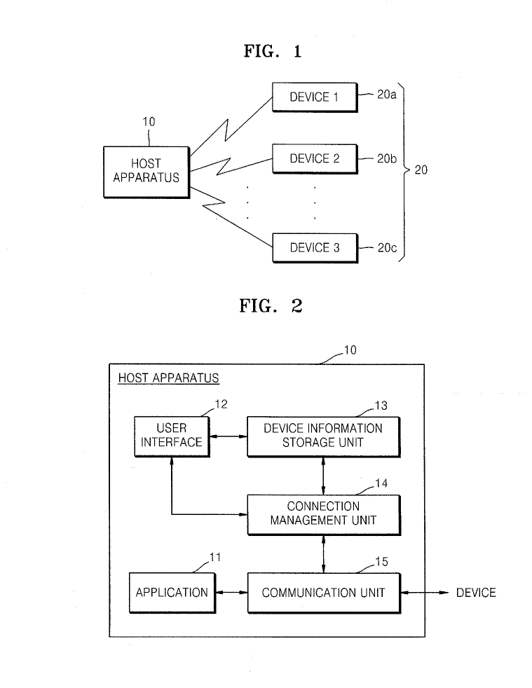

FIG. 1 is a structural block diagram of a wireless connection system including a host apparatus 10 and a plurality of devices 20a, 20b, and 20c, according to an embodiment of the present general inventive concept.

Each of the devices 20a, 20b, and 20c can connect with the host apparatus 10 using a wireless universal serial bus (USB). In FIG. 1, although individual devices are denoted by 20a, 20b, and 20c, hereinafter each of the devices is denoted by 20 for the convenience of explanation. That is, a device 20 refers to any of the devices 20a, 20b, and 20c in FIG. 1.

The host apparatus 10 acts as a wireless USB host for the device 20, and the host apparatus 10 may be, for example, a personal computer (PC), a laptop, or a workstation. The device 20 acts as a wireless USB client, and may be, for example, a keyboard, a mouse, or a printer.

The host apparatus 10 and the device 20 are previously associated with each other according to the wireless USB topology specification so as to connect with each other using the wireless USB. In the course of association, the host apparatus 10 and the device 20 share connection context which includes a connection host identification (CHID) for identifying the host apparatus 10, a connection device identification (CDID) for identifying the device 20, and a connection key for a secured communication. During association, the connection context is stored in a storage medium in each of the host apparatus 10 and the device 20.

After the association, the host apparatus 10 broadcasts information including its CHID to the device 20. The information of the host apparatus 10 is regularly broadcasted at predetermined time intervals.

The device 20 receives the broadcasted information, and sends a connection request signal, which includes the CDID of the device 20, to the host apparatus 10 when the same CHID as the CHID included in the information exists in the stored connection context. The connection between the host apparatus 10 and the device 20 is established when the host apparatus 10 responds to the connection request signal. According to the present embodiment, the host apparatus 10 stores a connection option for the device 20, and connects with the device 20 selectively in response to the connection request signal according to the connection option.

FIG. 2 is a detailed structural block diagram of the host apparatus 10 according to an embodiment of the present general inventive concept. The host apparatus 10 has at least one application 11 installed therein and includes a user interface 12, a device information storage unit 13, a connection management unit 14, and a communication unit 15. Also, although not illustrated, the host apparatus 10 includes a host driver which operates the host apparatus 10 to act as a wireless USB host and interprets data received from the device 20 and transfers the interpreted data to a corresponding application, and device drivers to operate each of the devices 20a, 20b, and 20c.

The communication unit 15 sends and receives data to each of the devices 20a, 20b, and 20c. More specifically, the communication unit 15 sends the devices 20 information including the CHID, which is created by the connection management unit 14, receives connection request signals from the devices 20, and sends the devices 20 a response signal, which is created by the connection management unit 14, in response to the connection request signals. In addition, the communication unit 15 sends and receives data to/from the devices 20 in the course of authentication and data communication procedures after establishing the connection between the host apparatus 10 and the devices 20.

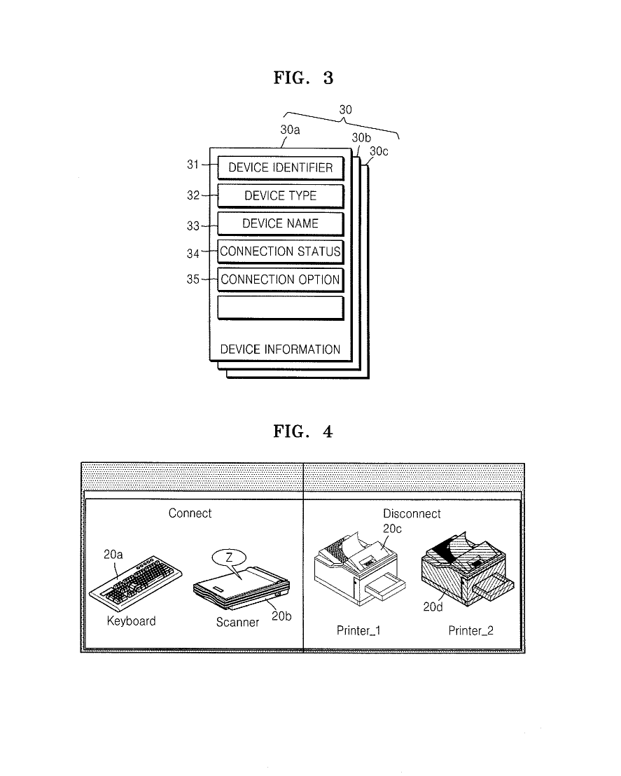

The device information storage unit 13 stores device information 30 (see FIG. 3) indicating setting values and statuses of individual devices. The device information 30 may be created after associating between the host apparatus 10 and a corresponding device. The device information 30 can control the connection between the host apparatus 10 and the device 20.

FIG. 3 is a block diagram illustrating a data structure of device information 30 according to an embodiment of the present general inventive concept. Each of a plurality of devices 20 has its own device information 30. For example, pieces of device information 30a, 30b, and 30c may correspond to the devices 20a, 20b, and 20c illustrated in FIG. 1, respectively.

Referring to FIG. 3, the device information 30 includes properties such as a device identifier 31, a device type 32, a device name 33, a connection status 34, and a connection option 35.

The device identifier 31 comprises unique identification information of a device 20, and, for example, a CDID can be used as the device identifier 31. The device type 32 indicates the type of device, and a device class may be used as the device type 32. The device name 33 enables the user to identify the device 20 from other devices 20 and can be created by the user, or if the user does not assign any name to the device 20, the device name 33 can be automatically set according to a predetermined rule.

The connection status 34 indicates how the host apparatus 10 and the device 20 are connected therebetween. The connection status 34 is updated in real-time according to data of the connection management unit 14 which monitors the device 20. The connection status 34 can include the following statuses:

1. Connected: the device 20 has been appropriately connected with the host apparatus 10, and the host apparatus 10 is currently using the device 20.

2. Sleep: although the device 20 has been appropriately connected with the host apparatus 10, the device 20 enters a standby mode when it has not been used for a predetermined period of time.

3. Non-authentication: while the connection between the host apparatus 10 and the device 20 is established in response to the connection request signal of the device 20, the authentication has not been performed. After the authentication, data communication between the host apparatus 10 and the device 20 can be commenced.

4. Waiting-connect: the host apparatus 10 is receiving a connecting request signal from the device 20, but the host apparatus 10 has not responded to the connection request signal and thus a connection between the host apparatus 10 and the device 20 is not established.

5. Not-available: the connection request signal is not received since the device 20 is powered off or another host apparatus is using the device 20.

Among the five statuses described above, in the first three statuses, the device 20 is connected with the host apparatus 10, and in the latter two statuses, the device is not connected with the host apparatus 10.

The connection option 35 includes device information 30 indicating if the device is in standby mode until receiving a connection command that permits the connection before the host apparatus 10 responds to the connection request signal of the device 20, and includes information about an automatic connection mode or manual connection mode.

In the automatic connection mode, the device 20 is allowed to connect with the host apparatus 10 regardless of the connection command of a user, and in the manual connection mode, the device is allowed to connect with the host apparatus 10 only when the connection command of the user is issued even if the connection request signal is received from the device 20. The connection mode 35 is set by the user through the user interface 12 which will be described later. The connection mode 35 may be set in the course of creating the device information 30 after association, or may be set after creating the device information 30. However, if the user does not set the connection mode 35 while the device information 30 is being created, the connection mode 35 may be set as a default value, for example, the automatic connection.

The properties of the device information 30 may have various forms of items other than the items described above. For example, the type of icons which will be used to display the devices through the user interface 12 may be one of the properties.

The connection management unit 14 performs functions related to connection with and authentication of devices 20. More specifically, the host apparatus 10 creates information including the CHID, broadcasts the information to the devices 20 through the communication unit 15, creates a response signal responding to the connection request signal from the device 20, and sends the response signal to the device 20 through the communication unit 15. Furthermore, the connection management unit 15 monitors the connection statuses of the devices 20, and updates the connection status among the device information 30 which is stored in the device information storage unit 13. Then, once the connection with the device 20 is established, the association between the host apparatus 10 and the device 20 is performed.

The connection management unit 14 selectively responds to each of the connection request signals of the devices 20 according to the connection options stored in the device 20. For example, the connection option of the device 20a illustrated in FIG. 1 may be the automatic connection, the connection management unit 14 immediately responds to the connection request signal upon receiving the connection request signal from the device 20a, and sends a response signal to the device 20a so that the device is enabled to connect with the host apparatus 10. However, if the connection option of the device 20b illustrated in FIG. 1 is the manual connection, the connection management unit 14 does not respond to the connection request signal even when receiving the connection request signal from the device 20b. Then, only when a connection command is generated by the user, does the connection management unit 14 respond to the connection request signal of the device 20b, sending a response signal to the device 20b, thus enabling the device 20b to connect with the host apparatus 10.

In addition, when receiving a connection termination command for the device 20 from the user, the connection management unit 14 sends a connection termination request signal to the device 20 so as to terminate the connection with the device 20.

Through the user interface 12, the device name 33 and a connection option 35 are among the device information 30 which are stored in the device information storage unit 13, as set by the user, and the connection command or the connection termination command for each device 20 is received. Moreover, the user interface 12 displays the devices 20 which are connected and are not connected with the host apparatus 10 with reference to the connection statuses among the device information 30 so as to facilitate the user's recognition of the devices 20. For example, the user interface 12 may display the device 20 which is connected with the host apparatus 10 and the devices 20 which are not connected with the host apparatus 10 in different windows so that the user can distinguish the connected devices 20 and the unconnected devices 20. Moreover, the user interface 12 may display the connection status of the device 20 more specifically with reference to the connection status among the device information 30. The user interface 12 displays status information which indicates the connection status between the host apparatus 10 and one or more devices 20. The status information may include one or more statuses comprising the connected status in which the connection between the devices 20 and the host apparatus 10 is established and authentication is already performed, the sleep status in which the devices 20 are in a standby mode after establishing the connection between the devices 20 and the host apparatus 10, the non-authentication status in which the connection between the devices and the host apparatus 10 has been established but authentication has not been performed yet, the waiting-connect status in which the host apparatus 10 receives the connection request signal but has not yet responded to the signal, and the not-available status in which the host apparatus 10 does not receive the connection request.

FIG. 4 illustrates an example of displaying devices 20 through the user interface 12, according to an embodiment of the general inventive concept. Instances of individual devices 20 can be created after the association procedure, and as shown in FIG. 4, the instances of devices 20 may be displayed with icons through the user interface 12.

Referring to FIG. 4, the devices 20 which are connected with the host apparatus 10 are a keyboard 20a and a scanner 20b, which are located in the left window, and the devices 20 which are not connected with the host apparatus 10 are two printers 20c and 20d, respectively, which are located in the right window. According to the current embodiment of the general inventive concept to display the sleep status, a speech bubble in which “Z” is placed is used as shown in FIG. 4 on scanner 20b, and to display the non-available status, the device icon can be shaded like the printer 20d in FIG. 4.

Furthermore, through the user interface 12, the user can input the connection command or the connection termination command for the devices using drag-and-drop. For example, the user can input the connection termination command by dragging-and-dropping the scanner icon located in the left window to the right window. Also, the user can delete devices 20 through the user interface 12, and when the user deletes a device 20, the connection context for the corresponding device is deleted from the host apparatus 10.

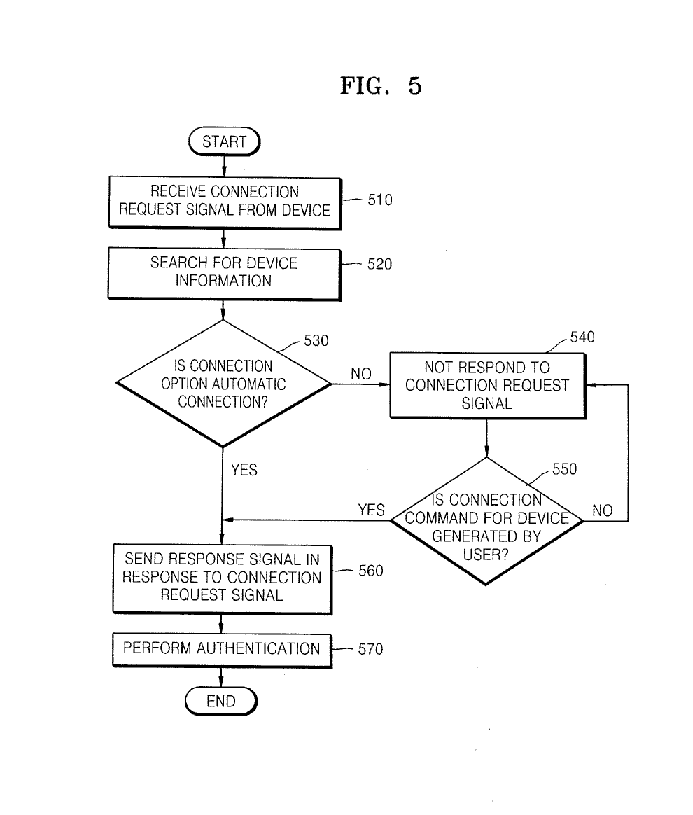

FIG. 5 is a flowchart illustrating a method of connecting a host apparatus with a device, according to an embodiment of the present general inventive concept. The connection method includes procedures performed in the host apparatus 10 illustrated in FIG. 2. Therefore, although the previous descriptions about the host apparatus 10 illustrated in FIG. 2 are not repeated, they are still applied to the connection method illustrated in FIG. 5.

In operation 510, the host apparatus 10 receives a connection request signal from the device 20.

In operation 520, the host apparatus 10 searches for device information 30 of the device 20 which has sent the connection request signal, by using CDID included in the received connection request signal.

In operation 530, the host apparatus 10 determines if the connection option included in the found device information is an automatic connection or a manual connection.

When it is determined that the connection option is the automatic connection, the procedure proceeds to operation 560 in which the host apparatus sends a response signal to the device 20 in response to the connection request signal.

When it is determined that the connection option is the manual connection, the procedure proceeds to operation 540, and the host apparatus 10 waits and does not respond to the connect request signal. During operations 510 to 540, the connection status of the device 20 is a waiting-connect status.

In operation 550, when a connection command for the device 20 is generated, the procedure continues to operation 560 in which the host apparatus 10 sends the response signal to the device 20 in response to the connection request signal. After operation 560, the connection status of the device 20 is a non-authentication status.

In operation 570, authentication between the host apparatus 10 and the device 20 is performed. In the course of authentication, the host apparatus 10 and the device 20 may perform a 4-way handshake using a connection key included in the connection context. After the authentication, the connection status of the device 20 is a connected status.

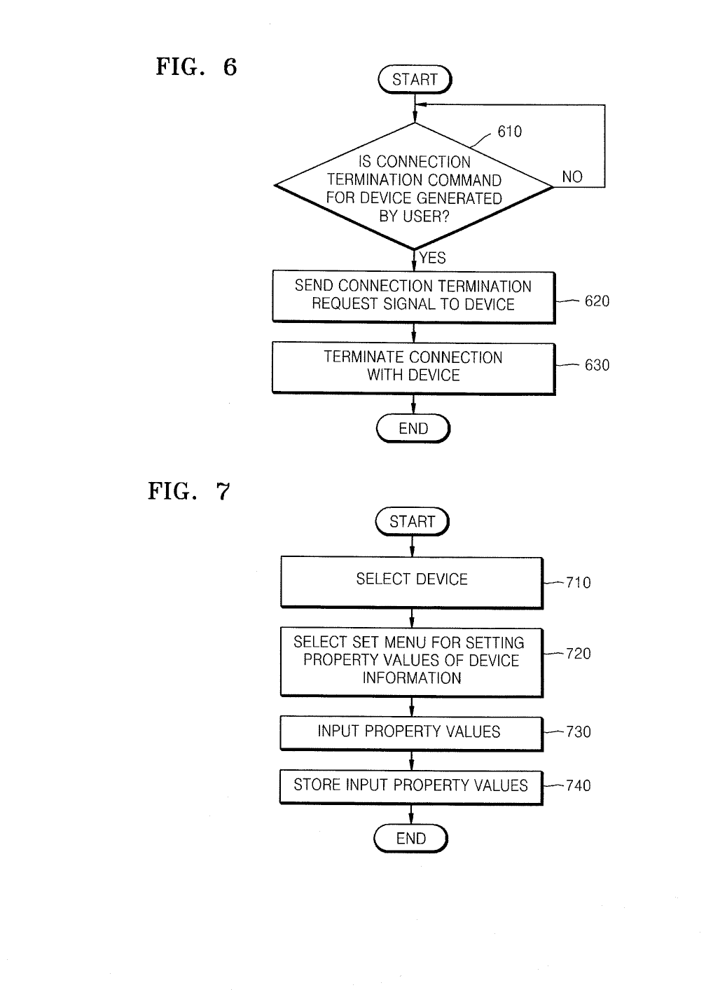

FIG. 6 is a flowchart illustrating a method of termination a connection between a host apparatus 10 and a device 20, according to an embodiment of the general inventive concept. Referring to FIG. 6, the connection termination method includes procedures performed in the host apparatus 10 illustrated in FIG. 2. Therefore, although previous descriptions about the host apparatus 10 illustrated in FIG. 2 are not repeated, they are still applied to the connection termination method illustrated in FIG. 6. In the current embodiment, it is assumed that the device 20 is already connected with the host apparatus 10 before operation 610 which will be described now.

When the user inputs a connection termination command in operation 610, the procedure continues to operation 620 where the host apparatus 10 sends the connection termination request signal to the device 20 so as to terminate the connection with the device 20.

In operation 630, the host apparatus 10 disconnects from the device 20. After operation 630, the device 20 is in a waiting-connect status.

FIG. 7 is a flowchart illustrating a method of setting property values of device information 30, according to an embodiment of the present general inventive concept. The setting method includes procedures performed in the host apparatus 10 illustrated in FIG. 2. Therefore, although previous descriptions about the host apparatus 10 illustrated in FIG. 2 are not repeated, they are still applied to the setting method illustrated in FIG. 7.

In operation 710, a user selects a device 20 from the user interface 12 to set property values of device information 30.

In operation 720, the user selects a menu for setting the property values of the device information 30 from the user interface 12.

In operation 730, the user inputs the property values, such as a device name, a connection option, an icon to display the device 20, through the user interface 12.

In operation 740, the host apparatus 10 stores the property values input in operation 730.

Some embodiments of the present general inventive concept can be written as computer programs and can be implemented in general-use digital computers that execute the programs using a computer readable recording medium. Also, the structure of the data used in some embodiments of the present general inventive concept can be written on a computer-readable recording medium by various means. Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet).

According to the present general inventive concept, a host apparatus 10 which can connect at least one or more devices 20 according to connection options preset in the devices 20 using a wireless universal serial bus (USB), and a method of connecting the host apparatus 10 with the devices 20 are provided. Thus, a device 20 can be connected with the host apparatus 10 only when a user wants, and thus user convenience increases in using and managing the device 20 through the host apparatus 10 in the USB environment.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of connecting a host apparatus with one or more devices by using a wireless universal serial bus (USB), the method comprising:
receiving a connection request signal to connect to the host apparatus from one of a plurality of devices; and
selectively responding to the connection request signal of the device according to preset device information.

2. The method of claim 1, wherein the device information includes a connection option which indicates whether the device waits until receiving a connection command to enable a connection between the host apparatus and the device to be established.

3. The method of claim 2, wherein the connection option includes an automatic connection or a manual connection.

4. The method of claim 2, wherein the connection option is set by a user, or is set in the course of association between the host apparatus and the device.

5. The method of claim 3, further comprising:
displaying status information which indicates the connection status of the connection between the one or more devices and the host apparatus to the user,
wherein the status information has at least one of a plurality of statuses including, a status in which the connection between the device and the host apparatus is established and authenticated, a status in which the device is connected with the host apparatus but the device is in a standby mode, a status in which the device and the host apparatus are connected with each other but authentication is not performed, a status in which the host apparatus receives a connection request but does not respond, and a status in which the host apparatus does not receive a connection request.

6. The method of claim 5, further comprising:
sending a connection termination request signal to the device when a connection termination command for the device is generated by a user.

7. The method of claim 6, wherein the displaying of the status information includes displaying devices which are connected with the host apparatus in a first area, and displaying devices which are not connected with the host apparatus in a second area.

8. The method of claim 7, wherein the connection command for the device is generated by dragging-and-dropping one of the devices displayed in the second area to the first area and the connection termination command is generated by dragging-and-dropping one of the devices displayed in the first area to the second area.

9. The method of claim 7, wherein, each device has an associated set of connection context information for establishing connection with the host, such that when a user deletes one of the displayed devices, the connection context information associated with the deleted device is also deleted.

10. A computer readable medium having computer readable code to implement a method of connecting a host apparatus with one or more devices using a wireless USB, the method comprising:
receiving a connection request signal to connect to the host apparatus from one of a plurality of devices; and
selectively responding to the connection request signal of the device according to preset device information.

11. A host apparatus which can connect to one or more devices using a wireless USB, the host apparatus comprising:
a communication unit which receives connection request signals from the devices;
a storage unit which stores device information of each of the devices; and
a connection management unit which selectively responds to the received connection request signal of each device according to the device information.

12. The host apparatus of claim 11, wherein the device information has a connection option which instructs whether the device stands by until a connection command enabling the connection is received.

13. The host apparatus of claim 12, wherein the connection option includes an automatic connection and a manual option.

14. The host apparatus of claim 12, wherein the connection option is set by a user or is set in the course of association between the host apparatus and the device.

15. The host apparatus of claim 13, further comprising:
a user interface which displays status information indicating a connection status between the device and the host apparatus;
wherein the status information has at least one of a plurality of statuses including a status in which the connection between the device and the host apparatus is established and authenticated, a status in which the device is connected with the host apparatus but the device is in a standby mode, a status in which the device and the host apparatus are connected with each other but authentication is not performed, a status in which the host apparatus receives a connection request but does not respond, and a status in which the host apparatus does not receive a connection request.

16. The host apparatus of claim 15, wherein, when a connection termination command for the device is generated by a user, the connection management unit sends a connection termination request signal to the device through the communication unit.

17. The host apparatus of claim 16, wherein the user interface displays devices which are connected with the host apparatus in a first area and devices which are not connected with the host apparatus in a second area.

18. The host apparatus of claim 17, wherein the connection management unit receives a connection command which is generated by dragging-and-dropping the devices displayed in the second area to the first area, and receives a connection termination command which is generated by dragging-and-dropping the devices displayed in the first area to the second area.

19. The host apparatus of claim 17, wherein, when a user deletes one of the displayed devices, the connection management unit deletes a connection context which is a set of information for connecting the host apparatus and the deleted device.

20. A method of controlling a communications system having a host apparatus, a wireless universal serial bus and at least one electronic device, the method comprising:
receiving a connection request signal to connect the host apparatus to at least one of the devices, and at least one of the devices including structure to store a set of device information, the device information including a connection option wherein the device waits until receiving a connection command from the host apparatus to enable a connection between the host apparatus and the device; and
selectively responding to the connection request signal of the device according to preset device information.
